(19) United States
(12) Patent Application Publication
(10) Pub. No.: US 2015/0111444 A1
(43) Pub. Date: Apr. 23, 2015

(54) JOINT TERMINAL

(71) Applicant: YAZAKI CORPORATION, Tokyo (JP)

(72) Inventor: Nobuyuki SAKAMOTO, Makinohara-shi (JP)

(21) Appl. No.: 14/583,246

(22) Filed: Dec. 26, 2014

Related U.S. Application Data
(63) Continuation of application No. PCT/JP2013/067539, filed on Jun. 26, 2013.

(30) Foreign Application Priority Data
Jul. 3, 2012 (JP) 2012-149400

(51) Int. Cl. H01R 13/05

(52) U.S. Cl. CPC H01R 13/05
USPC 439/888

(57) ABSTRACT

A joint terminal includes a wire connecting portion to which a wire is connected, and a terminal body coupled to the wire connecting portion. The terminal body comes into contact with the terminal body of the adjacent joint terminal. The wire connecting portion is located at an offset position with respect to the terminal body.

### CROSS REFERENCE TO RELATED APPLICATION

This is a continuation application based on PCT application No. PCT/JP2013/067539 filed on Jun. 26, 2013, which claims the benefit of priority from Japanese Patent Application No. 2012-149400 filed on Jul. 3, 2012, the entire contents of which are incorporated by reference herein.

### BACKGROUND OF THE INVENTION

1. Field of the Invention

The present invention relates to a joint terminal formed in a manner such that a conductive plate having a prescribed shape is subjected to bending processing.

2. Description of the Related Art

There has been known a joint terminal connected to a terminal of each wire, in which a plurality of joint terminals are brought into contact with each other so that the plurality of wires are electrically connected together (for example, refer to Japanese Unexamined Patent Application Publication No. 2007-087810). This type of joint terminal is formed in a manner such that a conductive plate having a prescribed shape is subjected to bending processing.

In particular, a joint terminal includes a wire connecting portion to which a wire is connected, and a box-shaped terminal body integrated with the wire connecting portion. The terminal body is provided, at one side wall, with a male contact piece (a tongue-shaped engaging piece) bent substantially into an L-shape and open toward the tip of the terminal body. The terminal body is provided, at the other side wall, with a female insertion hole into which a male contact piece of an adjacent joint terminal is inserted.

The male contact piece of one joint terminal inserted into the female insertion hole of the other joint terminal is brought into contact with a female contact point formed in the terminal body of the other joint terminal. The joint terminals adjacent to each other are thus electrically connected together due to the contact of the male contact piece of one joint terminal with the female contact point of the other joint terminal through the female insertion hole of the other joint terminal.

Since the male contact piece of such a conventional joint terminal projects from one side wall of the terminal body, the male contact piece of one joint terminal may come into contact with the wire connecting portion of the other joint terminal when the joint terminals adjacent to each other are connected together (namely, when the male contact piece of one joint terminal is inserted into the female insertion hole of the other joint terminal). Thus, the joint terminals adjacent to each other are required to be connected together without bringing the male contact piece of one joint terminal into contact with the wire connecting portion of the other joint terminal. This complicates the operation of connection of the joint terminals adjacent to each other.

### SUMMARY OF THE INVENTION

An object of the present invention is to provide a joint terminal capable of facilitating the operation in which the joint terminal is connected to an adjacent joint terminal while preventing interference of a wire connecting portion of the adjacent joint terminal when terminal bodies adjacent to each other are connected together.

A first aspect of the present invention provides a joint terminal electrically connected to an adjacent joint terminal, the joint terminal including: a wire connecting portion connected with a wire; and a terminal body coupled to the wire connecting portion; wherein the terminal body is brought into contact with a terminal body of the adjacent joint terminal, the wire connecting portion is located at an offset position with respect to the terminal body.

According to the first aspect, the wire connecting portion is located at the offset position with respect to the terminal body. Thus, the operation of connection of the joint terminals adjacent to each other can be facilitated without interference of the wire connecting portion of the adjacent joint terminal when the terminal bodies adjacent to each other are connected together.

A second aspect of the present invention provides the joint terminal according to the first aspect, wherein: the terminal body includes, a first side wall surface provided with a male contact piece projecting outward and elongated in an extending direction from tip to end of the terminal body, and a second side wall surface provided with a female slit into which a male contact piece of the adjacent joint terminal is inserted, the second side wall surface being opposed to the first side wall surface; and the wire connecting portion is located at an offset position toward the first side wall surface.

According to the second aspect, the wire connecting portion is located at the offset position toward the first side wall. This prevents the male contact piece from coming into contact with the wire connecting portion of the adjacent joint terminal when the male contact piece is inserted into the female slit of the adjacent joint terminal. Accordingly, the operation of connection of the joint terminals adjacent to each other can be facilitated without interference of the wire connecting portion of the adjacent joint terminal when the male contact piece is inserted into the female slit of the adjacent joint terminal.

According to the aspects of the present invention, the joint terminal can be provided capable of facilitating the operation in which the joint terminal is connected to an adjacent joint terminal while preventing interference of the wire connecting portion of the adjacent joint terminal when the terminal bodies adjacent to each other are connected together.

### BRIEF DESCRIPTION OF THE DRAWINGS

FIG. 1 is a disconnected perspective view showing a joint connector according to an embodiment of the present invention.

FIG. 2 is an assembled perspective view showing the joint connector according to the embodiment of the present invention.

FIG. 3 is a cross-sectional view showing the joint connector according to the embodiment of the present invention.

FIG. 4A is a perspective view showing a joint terminal according to the embodiment of the present invention as viewed from an upper wall side thereof.

FIG. 4B a perspective view showing the joint terminal according to the embodiment of the present invention as viewed from the upper wall side thereof.

FIG. 5A is a perspective view showing the joint terminal according to the embodiment of the present invention as viewed from a bottom wall side thereof.

FIG. 5B is a perspective view showing the joint terminal according to the embodiment of the present invention as viewed from the bottom wall side thereof.

FIG. 6 is a developed view showing the joint terminal according to the embodiment of the present invention.

FIG. 7A is a view showing a process of assembly of the joint connector according to the embodiment of the present invention.

FIG. 7B is a view showing the process of assembly of the joint connector according to the embodiment of the present invention.

FIG. 8A is a plan view showing the inside of the joint connector according to the embodiment of the present invention.

FIG. 8B is a rear view showing the joint connector according to the embodiment of the present invention.

### DESCRIPTION OF THE EMBODIMENTS

A joint connector including a joint terminal according to an embodiment of the present invention will be described below with reference to the drawings. Here, the same or similar elements in the following description of the drawings are indicated by the same or similar reference numerals. It should be noted that the respective elements are schematically shown in the drawings, and dimensional ratios in the drawings are different from actual ratios. The specific dimensions thus should be taken into consideration in accordance with the following description. In addition, the respective drawings may include the elements which are equivalent but differ in dimensional ratio.

### Configuration of Joint Connector

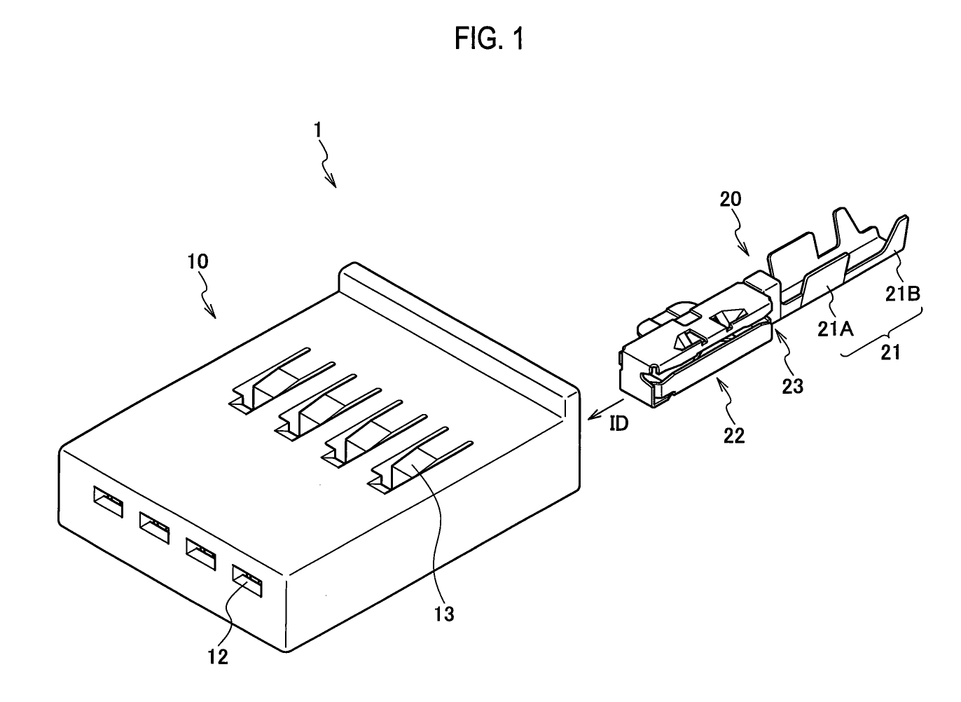

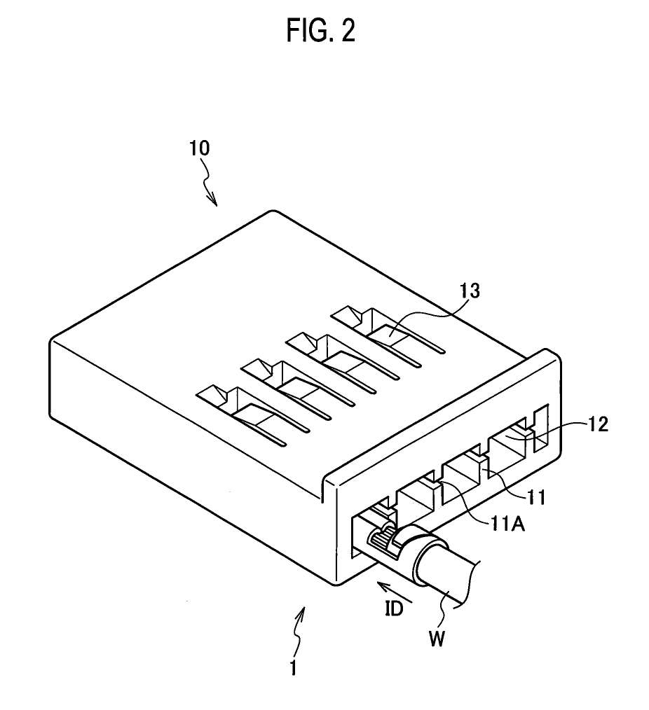

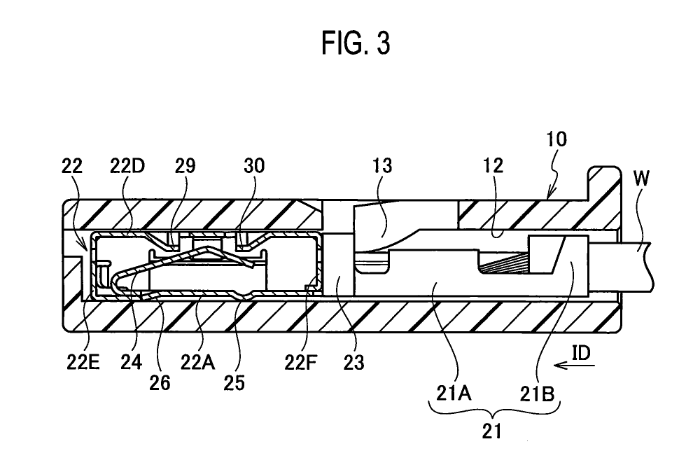

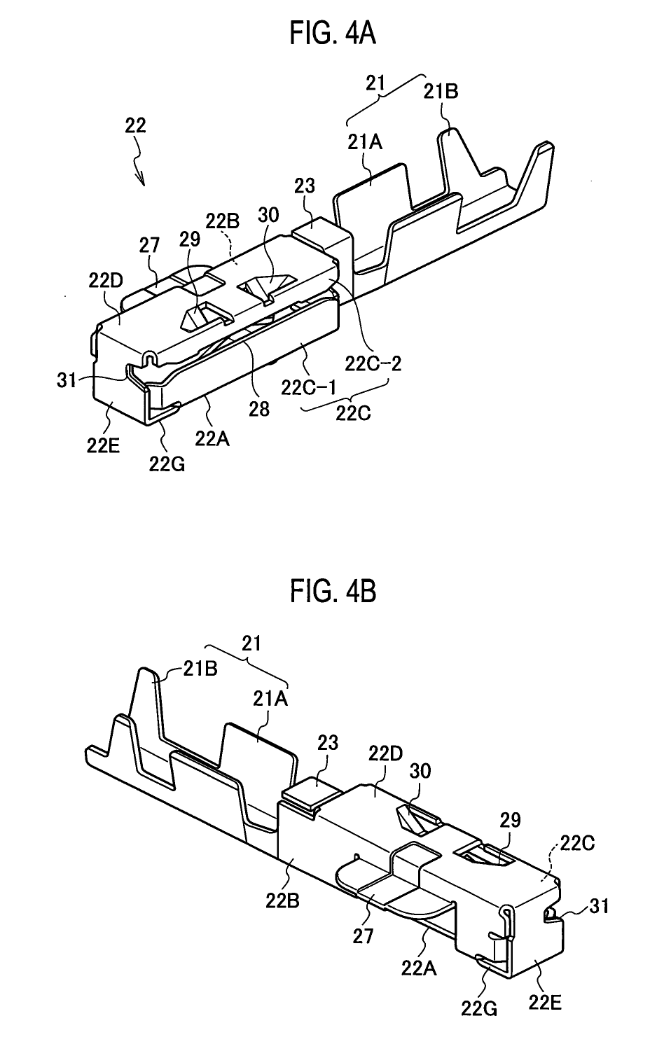

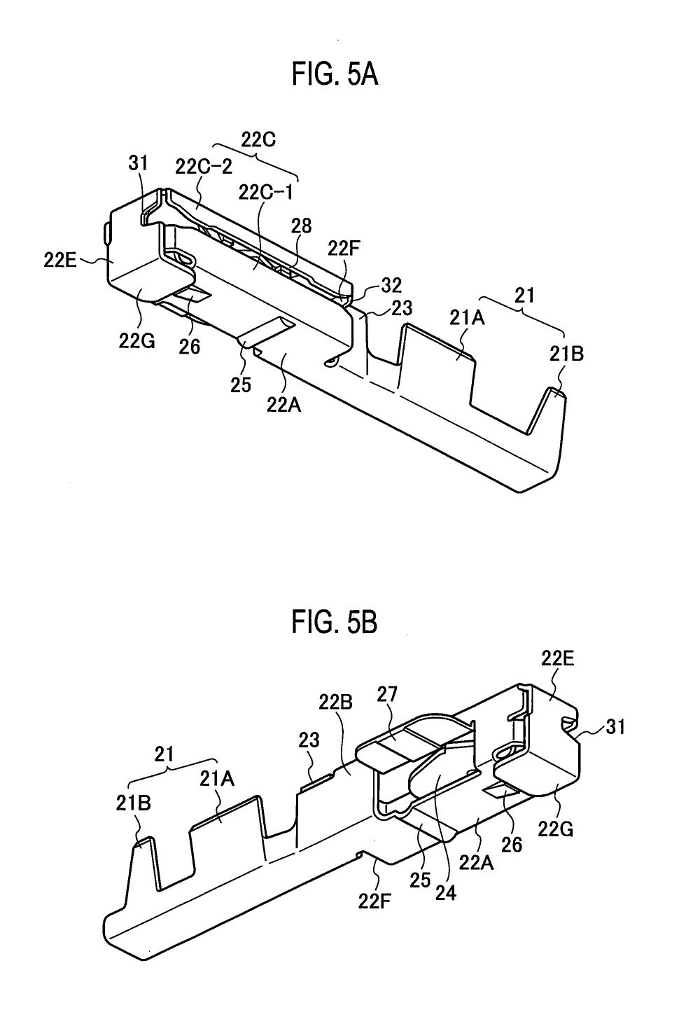

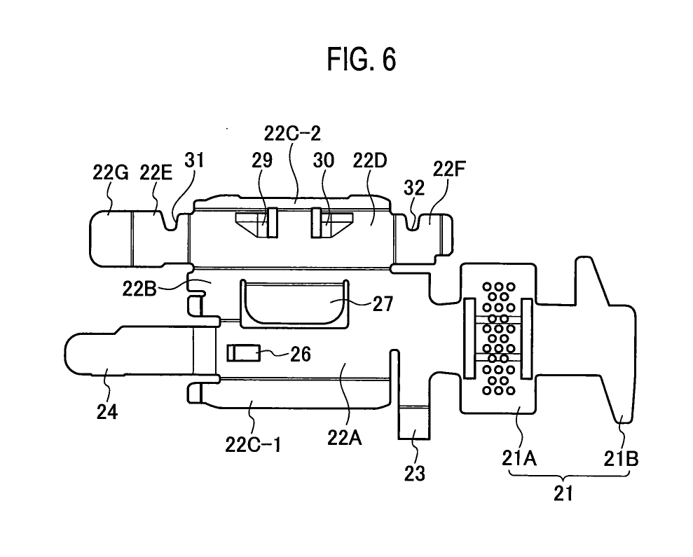

First, a configuration of a joint connector 1 according to the present embodiment will be described below with reference to the drawings. FIG. 1 is a disconnected perspective view showing the joint connector 1 according to the present embodiment. FIG. 2 is an assembled perspective view showing the joint connector according to the present embodiment. FIG. 3 is a cross-sectional view showing the joint connector 1 according to the present embodiment. FIGS. 4A and 4B and FIGS. 5A and 5B are perspective views each showing a joint terminal 20 according to the present embodiment. FIG. 6 is a developed view showing the joint terminal 20 according to the present embodiment.

As shown in FIG. 1 to FIG. 3, the joint connector 1 includes a connector housing 10 and a plurality of joint terminals 20 accommodated by the connector housing 10, and electrically connects the plural joint terminals 20 with each other inserted in the connector housing 10. Here, only one joint terminal 20 is shown in FIG. 1 and FIG. 2, and other joint terminals 20 are omitted in the figures.

The connector housing 10 is provided with a plurality of terminal compartments 12 defined by a plurality of partition walls 11. The partition walls 11 are each provided with a communication groove 11A (refer to FIG. 2) through which the respective terminal compartments 12 communicate with each other. The communication grooves 11A are each formed at a position displaced from the middle of the respective terminal compartments 12 in the vertical direction (toward the upper surface in the present embodiment).

The connector housing 10 is integrally provided with a plurality of lances 13 (refer to FIG. 1 and FIG. 3). The respective lances 13 protrude toward the inside of the corresponding terminal compartments 12 in a deformable manner.

The joint terminal 20 is formed in a manner such that a conductive plate having a prescribed shape shown in FIG. 6 is subjected to bending processing. The joint terminal 20 includes a wire connecting portion 21 to which a wire W is connected (refer to FIG. 2 and FIG. 3), a box-shaped terminal body 22 integrated with the wire connecting portion 21, and a lance locking portion 23 formed in the terminal body 22 toward the wire connecting portion 21 to lock the lance 13.

The wire connecting portion 21 includes a core press-fastening portion 21A for fastening a core of the wire W with pressure, and an insulation-layer press-fastening portion 21B for fastening an insulation layer covering the core of the wire W with pressure. The wire connecting portion 21 is formed at an offset position with respect to the terminal body 22 (toward a side wall 22B described later) so as not to come into contact with the terminal body 22 (a male contact piece 27 described later) of the other joint terminal 20 adjacent thereto when the joint terminal 20 is inserted into the connector housing 10.

The terminal body 22 is elongated in the direction from tip to end thereof (hereinafter, referred to as “insertion direction ID” of the joint terminal 20 toward the connector housing 10). The terminal body 22 includes a bottom wall 22A, a pair of side walls 22B and 22C (a first side wall surface and a second side wall surface) and an upper wall 22D each of which is being elongated in the insertion direction ID of the joint terminal 20, and further includes a front wall surface 22E and a rear wall surface 22F arranged in the direction perpendicular to the insertion direction ID of the joint terminal 20.

The bottom wall 22A is integrated with a cantilever spring piece 24 folded back at the front end of the bottom wall 22A in the insertion direction ID of the joint terminal 20. The spring piece 24 serves as a female contact portion located inside the terminal body 22 to come into contact with the terminal body 22 (the male contact piece 27 described later) of the adjacent joint terminal 20.

The bottom wall 22A is further provided with a projection 25 and an inclined piece 26 formed in front of the projection 25 in the insertion direction ID of the joint terminal 20 toward the connector housing 10. The projection 25 projects to the level corresponding to the thickness of a tip bottom surface 22G bent rearward from the front wall surface 22E, so as to keep the balance of the joint terminal 20 inside the connector housing 10. The inclined piece 26 prevents the tip bottom surface 22G from being stuck in the terminal compartment 12 when the joint terminal 20 is removed from the connector housing 10.

The side wall 22B is provided with the male contact piece 27 projecting in such a manner as to be bent outward (in the horizontal direction) from the side wall 22B. The male contact piece 27 is arranged at an offset position from the middle of the side wall 22B in the vertical direction (toward the upper wall 22D of the side wall 22C in the present embodiment) to correspond to the position where the communication groove 11A is located. The male contact piece 27 is inserted into the communication groove 11A when the joint terminal 20 is attached to the connector housing 10.

The side wall 22C is opposed to the side wall 22B. The side wall 22C includes a bottom-side wall 22C-1 bent from the bottom wall 22A and an upper-side wall 22C-2 bent from the upper wall 22D. The bottom-side wall 22C-1 and the upper-side wall 22C-2 are separated from each other in the vertical direction.

In particular, the side wall 22C is provided with a female slit 28 into which the male contact piece 27 of the adjacent joint terminal 20 is inserted. The female slit 28 is elongated on the side wall 22C across the terminal body 22 in the insertion direction ID. The female slit 28 is arranged at an offset position from the middle of the side wall 22C in the vertical direction (toward the upper wall 22D of the side wall 22C in the present embodiment) to correspond to the position where the communication groove 11A is located, in the same manner as the male contact piece 27. The female slit 28 is formed in a manner such that both sides in the insertion direction ID are widened outward (toward the front wall surface 22E and the rear wall surface 22F).

The upper wall 22D is bent from the side wall 22B. The upper wall 22D is provided with contact portions 29 and 30 projecting toward the inside of the terminal body 22. The contact portions 29 and 30 each serve as a female contact portion located inside the terminal body 22 to come into contact with the male contact piece 27 of the adjacent joint terminal 20 in a manner similar to the spring piece 24.

Namely, when the joint terminal 20 is attached to the connector housing 10, the male contact piece 27 is inserted into the female slit 28 of the terminal body 22 of the adjacent joint terminal 20 through the communication groove 11A so as to be held between the spring piece 24 and the contact portions 29 and 30 each serving as a female contact portion in the adjacent joint terminal 20. As a result, the terminal bodies 22 adjacent to each other, namely the joint terminals 20 adjacent to each other are electrically connected together.

The front wall surface 22E is located at the front end of the terminal body 22 in the insertion direction ID and bent from the upper wall 22D. The rear wall surface 22F is located behind the front wall surface 22E in the insertion direction ID and bent from the upper wall 22D.

The front wall surface 22E and the rear wall surface 22F are provided with notches 31 and 32, respectively, through which the male contact piece 27 of the adjacent joint terminal 20 can pass, the notches being located along the female slit 28. The notches 31 and 32 are each arranged at a position corresponding to the respective positions of the male contact piece 27 and the female slit 28. The notches 31 and 32 are formed in such a manner as to be open toward the female slit 28 and reduced in width toward the side wall 22B from the side wall 22C side.

### Method of Assembly of Joint Connector 1

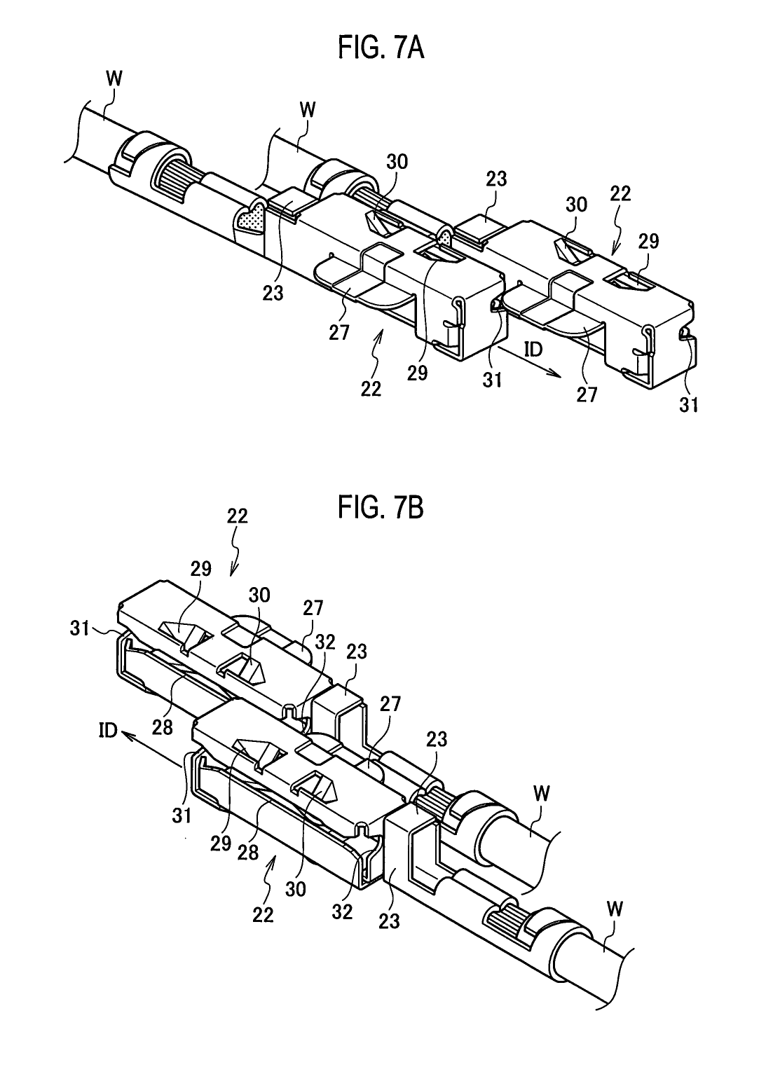

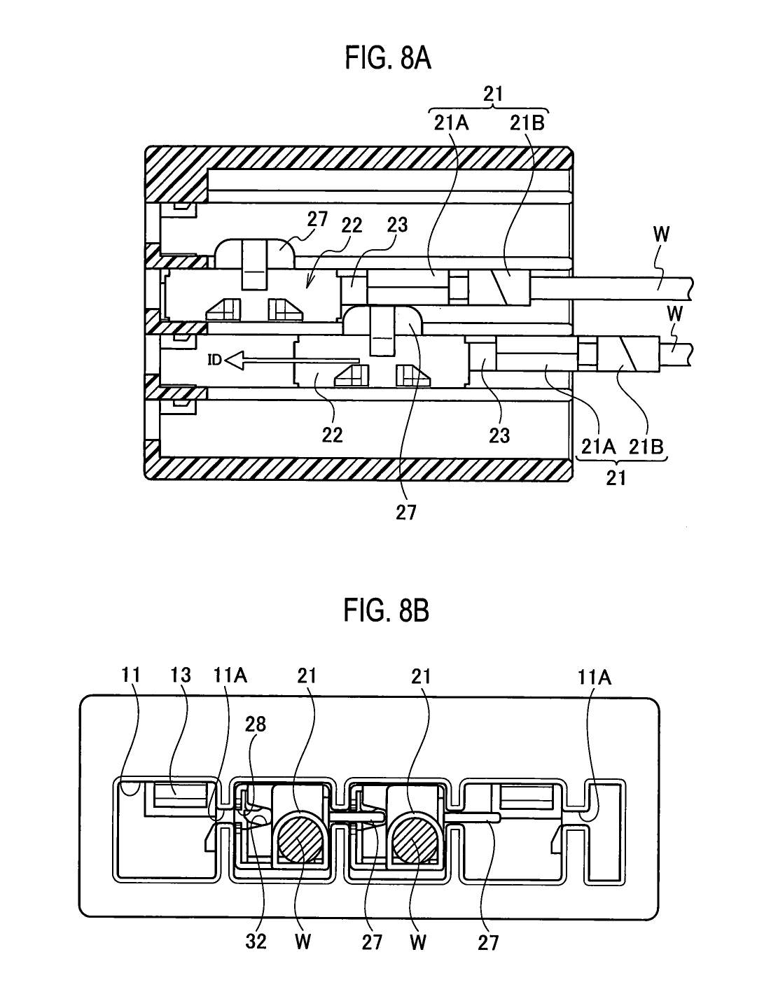

Next, a method of assembly of the joint connector 1 will be described briefly below with reference to the drawings. FIGS. 7A and 7B are views each showing a process of assembly of the joint connector 1 according to the present embodiment. FIG. 8A is a plan view showing the inside of the joint connector 1 according to the present embodiment. FIG. 8B is a rearview showing the joint connector 1 according to the present embodiment. Note that the connector housing 10 is not shown in either FIG. 7A or FIG. 7B.

Each of the join terminals 20 is inserted gradually into one of the terminal compartments 12 of the connector housing 10. The male contact piece 27 is then inserted gradually into the female slit 28 of the terminal body 22 of the adjacent joint terminal 20 through the communication groove 11A and the notches 31 and 32 of the adjacent joint terminal 20. Here, as shown in FIG. 8A and FIG. 8B, since the wire connecting portion 21 of the adjacent joint terminal 20 is located at the offset position with respect to the terminal body 22 thereof (toward the side wall 22B), the male contact piece 27 can be prevented from coming into contact with the wire connecting portion 21 of the adjacent joint terminal 20 when being inserted into the female slit 28 of the adjacent joint terminal 20.

Once the joint terminal 20 is completely fitted in the connector housing 10 (refer to FIG. 2 and FIG. 3), the male contact piece 27 is held between the spring piece 24 and the contact portions 29 and 30 of the adjacent joint terminal 20. As a result, the terminal bodies 22 adjacent to each other (namely, the joint terminals 20 adjacent to each other) are electrically connected together. Here, the female slit 28 is arranged to be elongated across the terminal body 22 in the insertion direction ID. Thus, the male contact piece 27 can be inserted from either the front wall surface 22E of the adjacent join terminal 20 as shown in FIG. 7A or the rear wall surface 22F of the adjacent joint terminal 20 as shown in FIG. 7B.

### Effects

In the above-described embodiment, the wire connecting portion 21 is located at the offset position with respect to the terminal body 22 (toward the side wall 22B). This configuration prevents the male contact piece 27 from coming into contact with the wire connecting portion 21 of the adjacent joint terminal 20 when the male contact piece 27 is inserted into the female slit 28. of the adjacent joint terminal 20. Accordingly, the operation of connection of the joint terminals 20 adjacent to each other can be facilitated without interference of the wire connecting portion 21 of the adjacent joint terminal 20 when the male contact piece 27 is inserted into the female slit 28 of the adjacent joint terminal 20.

In the present embodiment, the female slit 28 is elongated across the terminal body 22. Thus, the male contact piece 27 can be inserted and attached into the female slit 28 of the adjacent joint terminal from either the front end or the rear end of the terminal body 22 of the adjacent joint terminal 20. As a result, the operation of connection of the joint terminals 20 adjacent to each other can be facilitated without restriction on the procedure of attachment of the joint terminals 20 adjacent to each other.

### Other Embodiments

Although the details of the present invention have been disclosed by way of the embodiment described above, the present invention should not be deemed to be limited to the descriptions and the drawings composing part of the disclosure. It will be apparent to those skilled in the art from the disclosure that various alternative embodiments, examples and implementations can be made.

The embodiment of the present invention may be subjected to modification in some points. For example, the shape of the joint connector 1 is not limited to that described in the embodiment and may be decided as appropriate. Of course the shape of the connector housings 10 or the joint terminals 20 can also be decided as appropriate.

In addition, the communication grooves 11A are not necessarily displaced toward the upper surface from the middle of the terminal compartments 12 and may be located in the middle of the terminal compartments 12 or at a position displaced toward the lower surface from the middle of the terminal compartments 12. In any case, the male contact pieces 27, the female slits 28 and the notches 31 and 32 are only required to be formed at the position corresponding to the communication grooves 11A.

In addition, the wire connecting portion 21 is not necessarily located at the offset position toward the side walls 22B and may be located at an offset position toward the bottom wall 22A or the upper wall 22D.

The present invention can, of course, include various embodiments not described in this specification. Therefore, the scope of the present invention is defined only by the appropriate features according to the claims in view of the description made above.

What is claimed is:

1. A joint terminal electrically connected to an adjacent joint terminal, the joint terminal comprising:
a wire connecting portion connected with a wire; and
a terminal body coupled to the wire connecting portion;
wherein the terminal body is brought into contact with a terminal body of the adjacent joint terminal,
the wire connecting portion is located at an offset position with respect to the terminal body.

2. The joint terminal according to claim 1, wherein:
the terminal body includes,
a first side wall surface provided with a male contact piece projecting outward and elongated in an extending direction from tip to end of the terminal body, and
a second side wall surface provided with a female slit into which a male contact piece of the adjacent joint terminal is inserted, the second side wall surface being opposed to the first side wall surface; and
the wire connecting portion is located at an offset position toward the first side wall surface.

3. The joint terminal according to claim 2, wherein the terminal body is formed into a box shape in a manner such that a conductive plate having a prescribed shape is subjected to bending processing.

4. The joint terminal according to claim 3, wherein the terminal body further includes a female contact portion located inside the terminal body to come into contact with the male contact piece of the adjacent joint terminal inserted into the female slit.

5. The joint terminal according to claim 4, wherein the female slit is elongated across the terminal body in the extending direction of the terminal body.

6. The joint terminal according to claim 5, wherein both sides of the female slit in the extending direction of the terminal body are gradually widened outward.

7. The joint terminal according to claim 5, wherein:
the terminal body includes;
a front wall surface arranged in a direction perpendicular to the extending direction of the terminal body and located at a front end of the terminal body, and
a rear wall surface located at a rear end of the terminal body behind the front wall surface; and
the front wall surface and the rear wall surface are respectively provided with notches through which the male contact piece can pass, the notches being located along the female slit.
